(19) United States
(12) Patent Application Publication
(10) Pub. No.: US 2011/0052310 A1
(43) Pub. Date: Mar. 3, 2011

(54) Medical information and directives device

(76) Inventors: Kathy Yvette Jansen, Blaine, WA (US); Robin Marie Grangruth, Menifee, CA (US); Karen Renee Croy, Blaine, WA (US)

(21) Appl. No.: 12/868,966

(22) Filed: Aug. 26, 2010

Related U.S. Application Data
(60) Provisional application No. 61/237,251, filed on Aug. 26, 2009.

(51) Int. Cl. B42F 13/40

(52) U.S. Cl. 402/4

(57) ABSTRACT

A medical information and directives device is disclosed that enables users to accurately document his or her medical history and directives for personal or third party review. The device includes one or more areas for a user to fill in or include his or her personal medical information. A medication display and information board is also included with the device, whereby descriptions and samples of medications are stored and easily viewed. These features enable a relative or medical professional to quickly and accurately ascertain the exact medical history of an individual.

### CROSS REFERENCE TO RELATED APPLICATIONS

This application is a non-provisional application of U.S. Provisional Pat. App. No. 61/237,251 filed on Aug. 26, 2009, the entirety of which is hereby incorporated by reference.

### STATEMENT REGARDING FEDERALLY SPONSORED RESEARCH OR DEVELOPMENT

This invention was not federally sponsored.

### BACKGROUND OF THE INVENTION

### Field of the Invention

This invention relates to the general field of medical information devices, and more specifically toward a medical information and directives device that enables users to accurately document his or her medical history and directives for personal or third party review. The device includes one or more areas for a user to fill in or include his or her personal medical information. A medication display and information board is also included with the device, whereby descriptions and samples of medications are stored and easily viewed. These features enable a relative or medical professional to quickly and accurately ascertain the exact medical history of an individual.

Medical histories are vitally important to an individual's health care. Knowing what medications the patient is taking, what illnesses he or she may have, and his or her healthcare wishes are extremely important when treating that patient. For example, a patient that has high blood pressure may require emergency medical care where the standard treatment is to administer a drug that raises one's blood pressure. If the medical staff knows, however, that the patient has high blood pressure, they will be able to take that into consideration. Alternatively, if a patient is taking blood thinners and the treatment includes giving the patient blood thinners, then it is vital that the medical staff attending to the patient know what blood thinners have been given and how much.

Electronic medical records have been implemented in a wide variety of situations whereby medical staff can quickly and easily retrieve the records of a patient. However, these records can be incomplete, incorrect, or even non-existent if the patient is not in the system.

Medications are often administered in emergency situations without the benefit of knowing the patient's medical history. This can lead to over medication or adverse reactions to the mixing of drugs. Medical histories can also be helpful to aid emergency medical technicians in helping hurt individuals; such as if a patient has Alzheimer's and cannot remember that she also has osteoporosis and high blood pressure.

Many patients may also have special health directives that they want followed when receiving medical attention. For example, terminally ill patients may have “do not resuscitate” orders forbidding the use of extraordinary measures to bring them back to life. However, these are hard to follow if the medical staff is not aware of such an order.

Thus there has existed a long-felt need for a medical information and directives device that accurately and efficiently retains and dispenses medical information and directives to medical staff regarding the patient. It must enable a medical professional to know the medical conditions applicable to the patient as well as any medications that he or she may be taking. The device should also inform the medical staff as to what medical directives are in place for that patient.

### SUMMARY OF THE INVENTION

The current invention provides just such a solution by having a medical information and directives device that enables users to accurately document his or her medical history and directives for personal or third party review. The device includes one or more areas for a user to fill in or include his or her personal medical information. A medication display and information board is also included with the device, whereby descriptions and samples of medications are stored and easily viewed. These features enable a relative or medical professional to quickly and accurately ascertain the exact medical history of an individual.

It is a principal object of the invention to provide a device that accurately retains medical information about a particular individual, including medications taken by the individual.

It is another object of the invention to provide a device that dispenses the retained medical information in an efficient and effective manner.

It is a final object of this invention to provide a device the retains and dispenses medical directive information such that an individuals health care wishes and requirements are carried out to the fullest extent possible.

There has thus been outlined, rather broadly, the more important features of the invention in order that the detailed description thereof may be better understood, and in order that the present contribution to the art may be better appreciated. There are additional features of the invention that will be described hereinafter and which will form the subject matter of the claims appended hereto. The features listed herein and other features, aspects and advantages of the present invention will become better understood with reference to the following description and appended claims.

### BRIEF DESCRIPTION OF THE FIGURES

The accompanying drawings, which are incorporated in and form a part of this specification, illustrate embodiments of the invention and together with the description, serve to explain the principles of this invention.

FIG. 1 is a front perspective view of a medical information and directives device according to the current invention.

FIG. 2 is a back perspective view of the medical information and directives device.

FIG. 3 is a front perspective view of the medical information and directives device in an open configuration.

FIG. 4 is a front perspective view of an alternative embodiment of the medical information and directives device in an open configuration.

FIG. 5 is a front perspective view of the medical information and directives device in an open configuration that includes a medical display and information board.

FIG. 6 is a front perspective view of the medical display and information board.

FIG. 7 is a partial front perspective view of the medical display and information board showing access to pill compartments.

FIG. 8 is a partial front perspective view of the medical display and information board showing no access to the pill compartments.

FIG. 9 is a front perspective view of an alternative embodiment of the medical display and information board.

FIG. 10 is a back perspective view of an alternative embodiment of the medical display and information board.

### DETAILED DESCRIPTION OF THE INVENTION

Many aspects of the invention can be better understood with the references made to the drawings below. The components in the drawings are not necessarily drawn to scale. Instead, emphasis is placed upon clearly illustrating the components of the present invention. Moreover, like reference numerals designate corresponding parts through the several views in the drawings.

FIG. 1 is a front perspective view of a medical information and directives device according to the current invention. The medical information and directives device 10 (or simply the “device”) is shown with the mnemonic MEDI Center, which stands for Medical/Medicine Emergency Directives Information Center. The outside of the device 10 includes a handle 16 that a user may use to carry the device. A zipper 14 secures the device 10 in a closed configuration. A pull-tab 12 enables a user to unzip the zipper 14 and open the device 10 into an open configuration to gain access to the items and/or information contained therein.

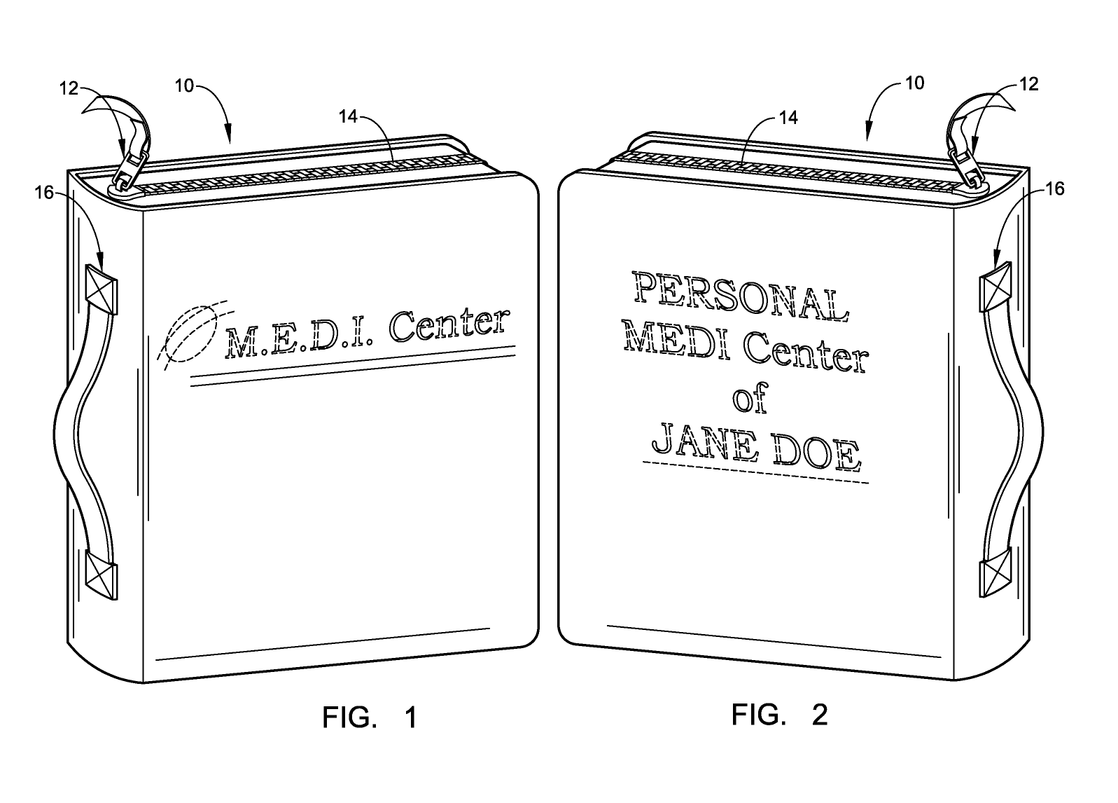

FIG. 2 is a back perspective view of the medical information and directives device. The device is shown with “PERSONAL MEDI Center of JANE DOE” on the back cover, where “JANE DOE” can be written, engraved, or otherwise affixed on the device by the user, or can be written, engraved, or otherwise affixed by the manufacturer, reseller, or other individual/entity for the user.

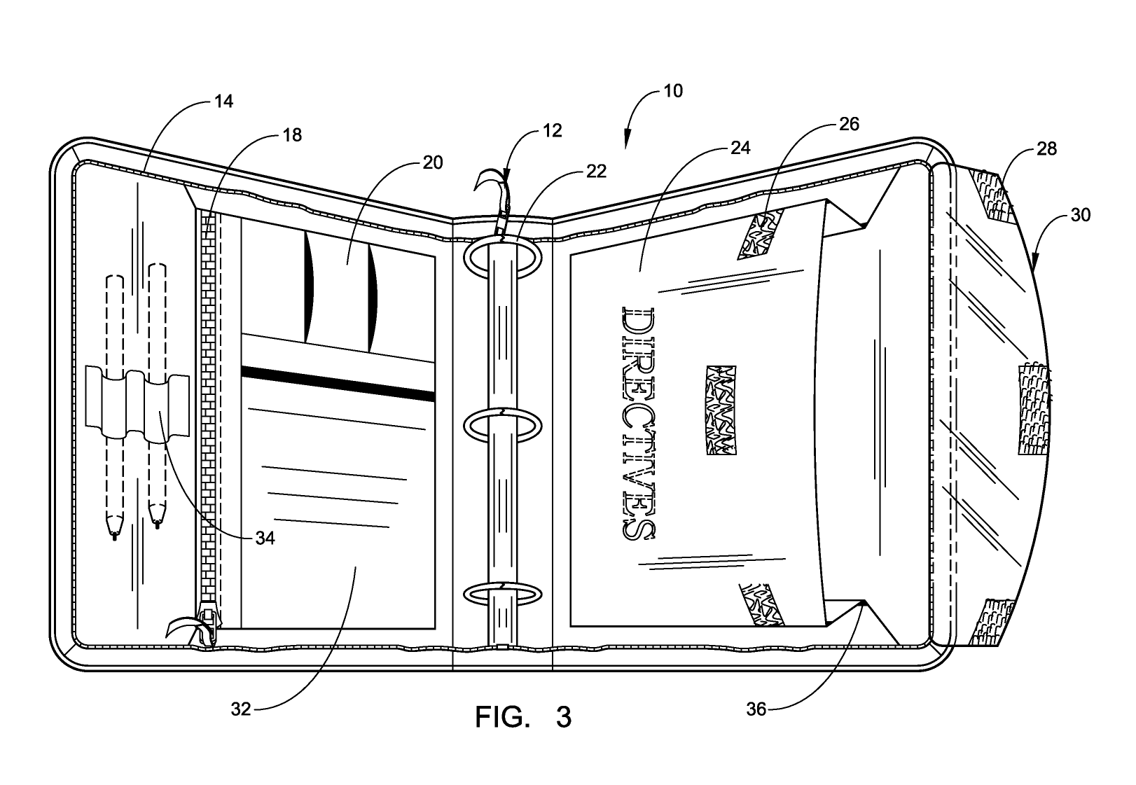

FIG. 3 is a front perspective view of the medical information and directives device in an open configuration. Inside of the device, there is a pocket 24 that stores various items, including medical directives. To this end, the pocket 24 is labeled with “DIRECTIVES” in this embodiment of the device 10. A closure 30 can be used to contain items within the pocket. Hook and loop fasteners 28 on the closure 30 mate with hook and loop fasteners 26 on the pocket 24. Alternative means of removably securing the closure to the pocket are contemplated, including magnets and static electricity. A fold 36 in the pocket 24 allows the pocket 24 to expand and collapse, thereby allowing for a larger or smaller area to store one or more items.

On the opposite side of the device, there is a space for writing 32, where users may write down specific information, preferably about their specific medical conditions. Above the space for writing 32 is a cardholder 20. Business cards or other similarly sized objects can be retained by the cardholder 20 for later reference. A compartment between the space for writing 32 and cardholder 20 is accessed by means of opening a zipper 18, where items may be secured therein by closing the zipper 18. Writing utensils, such as pencils, pens, and markers, can be retained by one or more sleeves 34. Three binder rings 22 are included with the device to secure one or more medical display and information boards and/or other items commonly secured by binder rings.

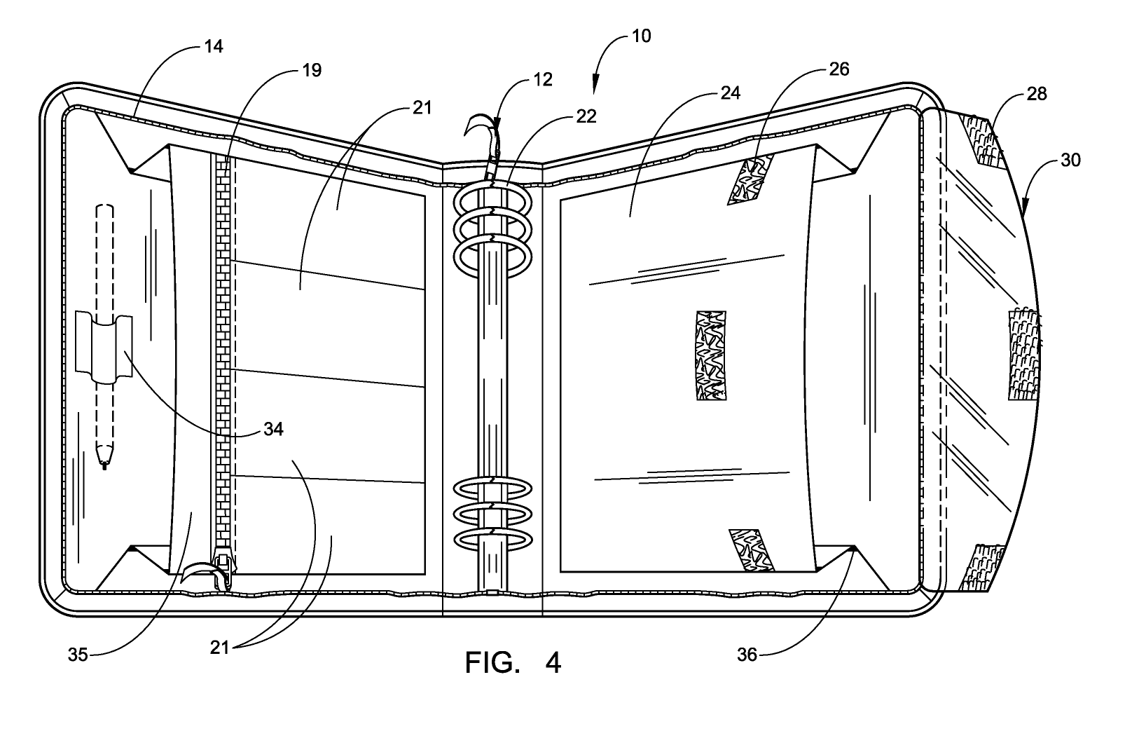

FIG. 4 is a front perspective view of an alternative embodiment of the medical information and directives device in an open configuration. Inside of the device, there is a pocket 24 that stores various items, include medical directives. A closure 30 can be used to contain items within the pocket. Hook and loop fasteners 28 on the closure 30 mate with hook and loop fasteners 26 on the pocket 24. Alternative means of removably securing the closure to the pocket are contemplated, including magnets and static electricity.

The opposite side of the device includes a secondary pocket 35. Four cardholders 21 are located outside of the pocket 35, wherein business cards, insurance cards, or other similarly sized objects may be stored. A compartment exists between the secondary pocket 35 and the cardholders 21 that is accessed by means of a zipper 19. Six binder rings 22 are included with the device to secure one or more medical display and information boards and/or other items commonly secured by binder rings.

A voice recorder can be included with the current invention that can serve various functions. The user can record a message for him or her to listen to at a later date, which is especially beneficial to those users that have difficulty writing. Others can record messages for the user, which can be particularly beneficial for those that are blind. The voice recorder can be integrated into the device to replace one or more of the cardholders.

An electronic memory card, such as a CD-ROM, flash drive, or similar memory card can be included with the device and preferably stored in one of the cardholders or removably integrated into the device instead of one of the cardholders. The electronic memory card enables the quick and efficient transfer of information concerning the user. The user or caregiver of a user can store important information on the electronic memory card that would be beneficial for a medical professional to have when treating the user. For example, the user's entire medical chart could be included on the electronic memory card such that if the user required medical attention at a remote facility, that facility could quickly and efficiently retrieve all of the user's relevant medical information. The electronic data can be formatted in a variety of ways, either open source or proprietary.

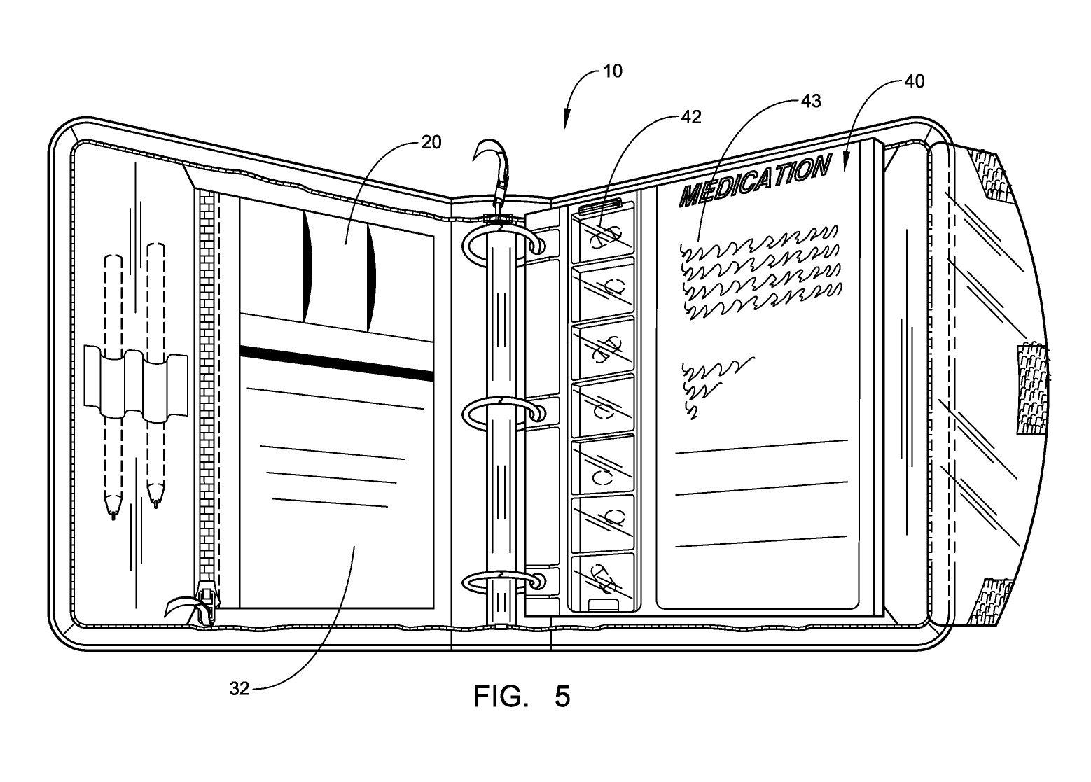

FIG. 5 is a front perspective view of the medical information and directives device in an open configuration that includes a medical display and information board. The medical display and information board 40 (or simply the “board”) is secured to the device 10 by placing the binder rings of the device 10 through the corresponding holes in the board 40. One or more pills may be contained within pill containers 42. A writing space 43 is provided to identify medications taken by the user, especially those contained within the pill containers 42, as well as other medically relevant information. Specifically, the writing space 43 is a preprinted form that includes spaces for a user to write in the name, dosage, frequency of usage, reason for taking the medication, prescribing doctor, and pharmacy of the drug located within the pill container proximate to the space thereby identifying the medication located in the corresponding pill container. While only one board 40 is shown attached to the device 10, it is contemplated that multiple boards 40 may be secured to the device at the same time depending upon the needs of the user.

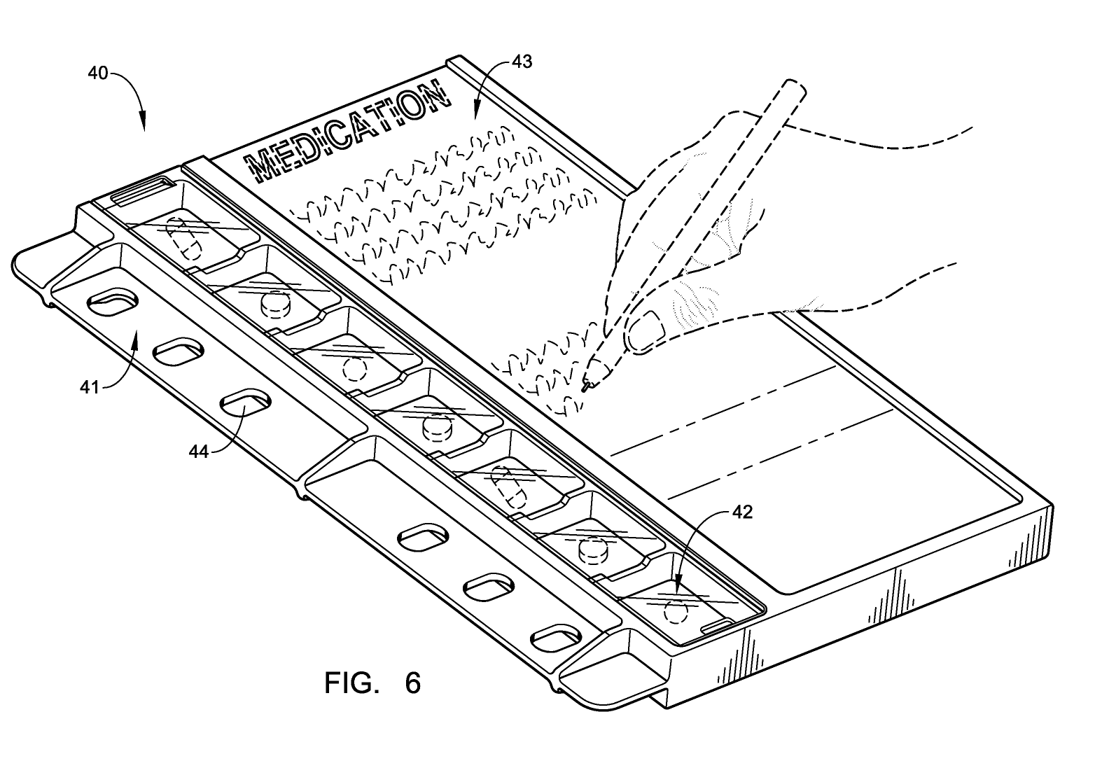

FIG. 6 is a front perspective view of the medical display and information board. The board 40 includes a plurality of pill containers 42. An attachment portion 41 includes a plurality of binder ring holes 44 to secure the board 40 to the binder rings of the device. A writing space 43 is provided to identify medications taken by the user, especially those contained within the pill containers 42, as well as other medically relevant information.

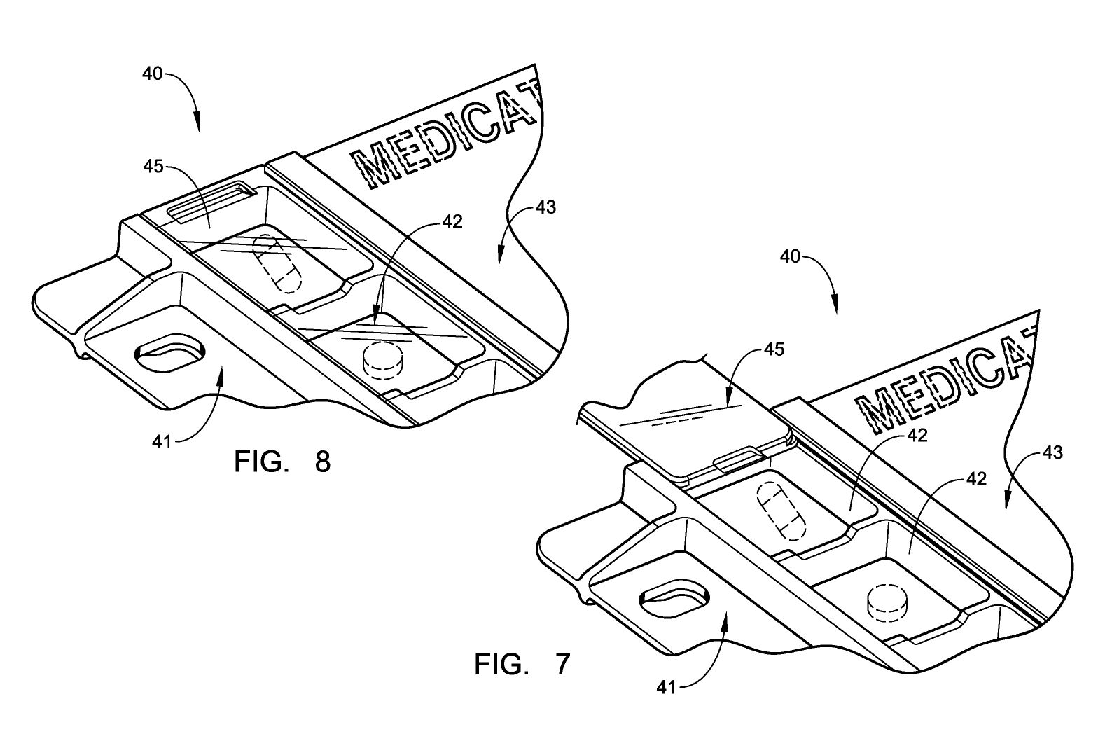

FIG. 7 is a partial front perspective view of the medical display and information board showing access to pill compartments. The pill compartments 42 are accessed by pulling out a clear cover 45. The clear cover 45 is preferably shaped with protrusions along its length that mate with corresponding rails of the board 40. Thus, the clear cover 45 can slide in and out within the rails, but cannot be lifted directly up and away from the board 40. The clear cover is preferably made from a plastic such that it is lightweight, strong, transparent or at least highly translucent, and shatter resistant. Glass is an unsuitable material for manufacturing the clear cover. While glass is transparent, it will shatter and may cause injury to users if broken.

FIG. 8 is a partial front perspective view of the medical display and information board showing no access to the pill compartments. The pill compartments are closed by sliding the clear cover 45 back over the pill compartments 42. The clear cover 45 can be locked in place to prevent unwanted access to the pills. For example, a zip tie can be used keep the clear cover 45 from sliding into and out of the board 40. The zip tie can go through a loop in the clear cover 45 and a corresponding loop in the board 40, thereby preventing the lateral movement of the clear cover 45. The protrusions along the length of the clear cover 45 and the rails of the board 40 prevent the perpendicular movement of the clear cover 45 away from the board 40.

In practice, a user will pull out the clear cover 45 in place a pill in each of the pill compartments 42. Then, the clear cover 45 is pushed back into place over the pills. The clear cover is preferably transparent, so as to allow for easy viewing of the pills contained within the pill containers 42 without removing the clear cover 45.

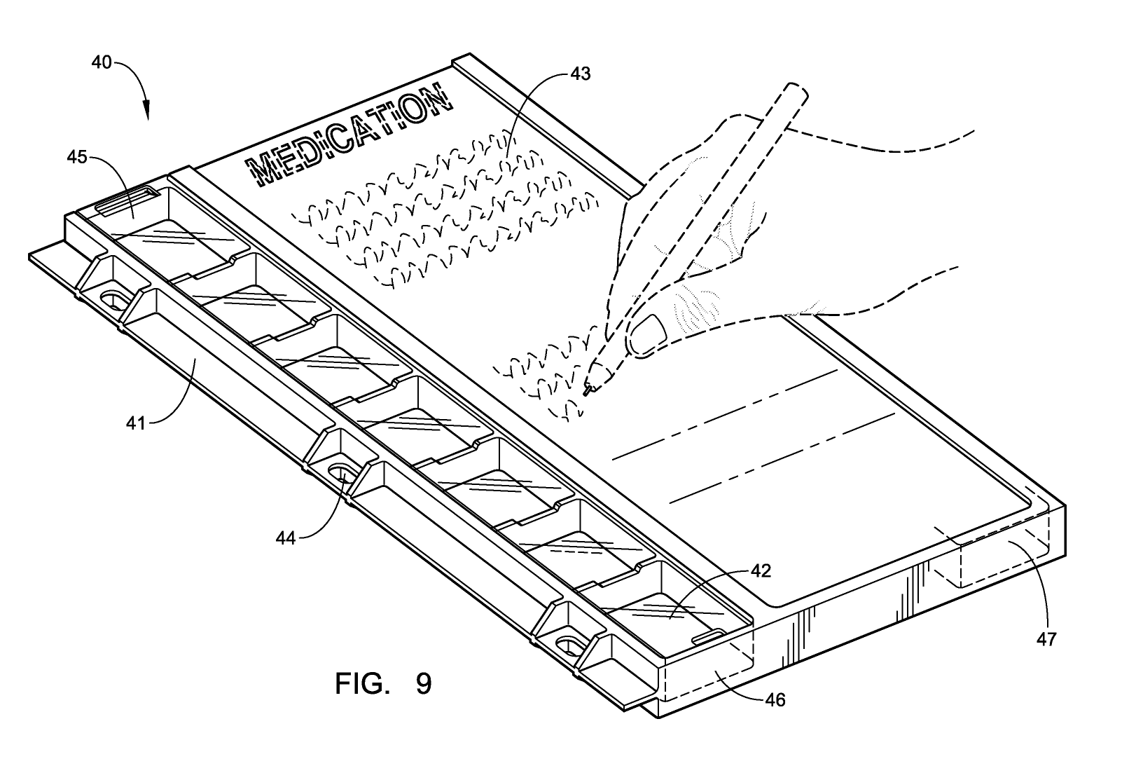

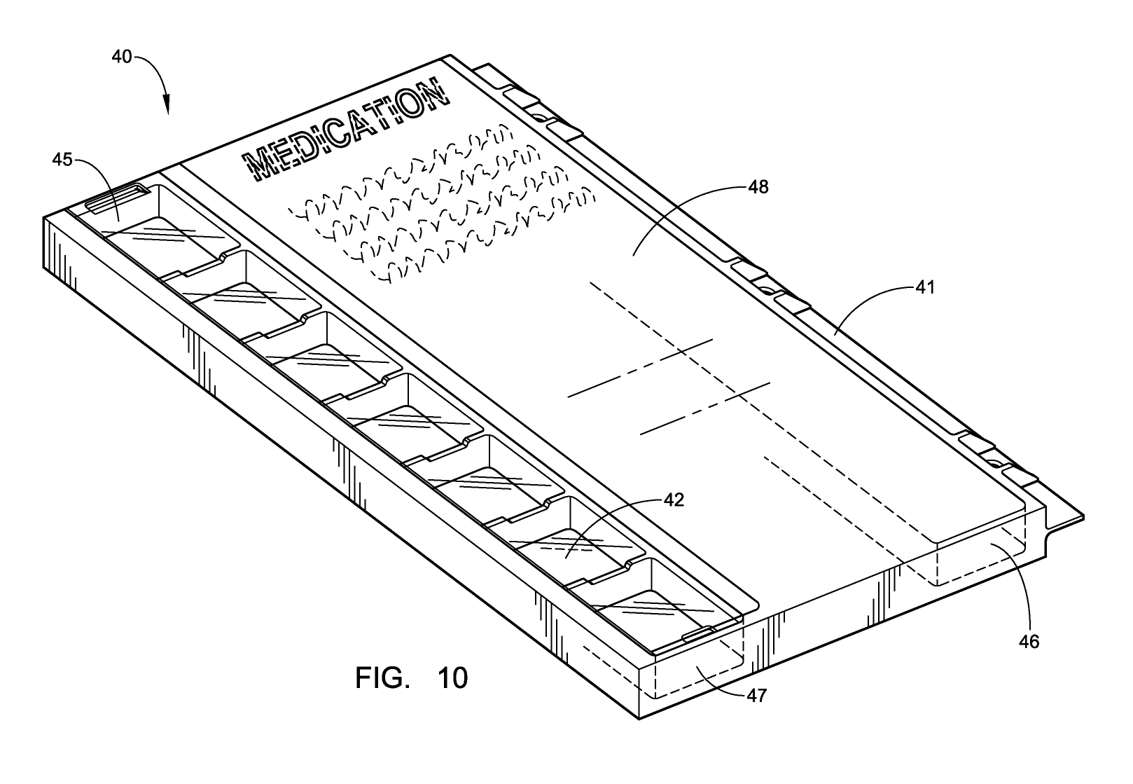

FIG. 9 is a front perspective view of an alternative embodiment of the medical display and information board. This embodiment includes two sets of pill containers, one on each side of the board 40. A first set of pill containers 46 located adjacent to the attachment portion 41 includes a plurality of pill containers 42 covered by a clear cover 45. A second set of pill containers is located on the opposite side of the board 40 from the attachment portion 41. Note that the second set of pill containers 46 cannot be accessed from the same side as the first set of pill containers 47.

FIG. 10 is a back perspective view of an alternative embodiment of the medical display and information board. In this figure, the second set of pill containers 47 includes pill containers 42 that are accessible by removing a clear cover 45. The back side of the board 40 also includes a second writing surface 48, whereby users may write what medications are taken by the user, especially those contained within the pill containers 42, as well as other medically relevant information.

The device may be designed in various shapes and sizes without departing from the scope of the current invention. In fact, larger or smaller sizes of the device are preferable depending on the specific needs of the user. For example, a user with few medications and medical conditions that travels significantly may require a smaller sized device with a single board. On the other hand, a user with many medications and complex medical conditions may require a larger sized device with multiple boards.

It should be understood that while the preferred embodiments of the invention are described in some detail herein, the present disclosure is made by way of example only and that variations and changes thereto are possible without departing from the subject matter coming within the scope of the following claims, and a reasonable equivalency thereof, which claims I regard as my invention.

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

That which is claimed:

1. A medical information and directives device comprising
an inside, an outside, and a means for opening and closing the device, where the means for opening and closing the device is a zipper with a pull-tab,
where the outside comprises a handle,
where the inside comprises a pocket, a pocket closure, a plurality of binder rings, a sleeve, and a medical display and information board,
where the pocket and the pocket closure each comprise mating hook and loop fasteners, where the pocket comprises a fold,
where the sleeve secures a writing utensil to the device,
where the medical display and information board comprises an attachment portion, a writing space, a first set of pill containers, and a removable clear cover, where the attachment portion secures the medical display and information board to the plurality of binder rings, where the first set of pill containers comprises a plurality of pill containers, where the clear cover encloses a pill within one of the plurality of pill containers.

2. The device of claim 1, further comprising a secondary pocket, a zipper, and a plurality of card holders, where the zipper provides access to a compartment between the secondary pocket and the plurality of card holders.

3. The device of claim 1, wherein the medical display and information board further comprises a second set of pill containers and second writing space, where the second set of pill containers comprises a plurality of pill containers, where the first set of pill containers and second set of pill containers are accessed on opposite sides of the medical display and information board.

4. A medical information and directives device comprising
an inside, an outside, and a means for opening and closing the device,
where the inside comprises a plurality of binder rings and a medical display and information board,
where the medical display and information board comprises an attachment portion, a writing space, a first set of pill containers, and a removable clear cover, where the attachment portion secures the medical display and information board to the plurality of binder rings, where the first set of pill containers comprises a plurality of pill containers.

5. The device of claim 4, wherein the means for opening and closing the device is a zipper with a pull-tab.

6. The device of claim 4, wherein the outside comprises a handle.

7. The device of claim 4, wherein the inside of the device further comprises a sleeve, where the sleeve secures a writing utensil to the device.

8. The device of claim 4, wherein the inside of the device further comprises a plurality of sleeves, where the sleeves secure writing utensils to the device

9. The device of claim 4, where the inside of the device further comprises a pocket and a pocket closure, where the pocket and the pocket closure each comprise mating hook and loop fasteners.

10. The device of claim 9, wherein the pocket comprises a fold.

11. The device of claim 4, further comprising a secondary pocket, a zipper, and a plurality of card holders, where the zipper provides access to a compartment between the secondary pocket and the plurality of card holders.

12. The device of claim 11, wherein the secondary pocket comprises a fold.

13. The device of claim 4, wherein the medical display and information board further comprises a second set of pill containers and second writing space, where the second set of pill containers comprises a plurality of pill containers, where the first set of pill containers and second set of pill containers are accessed on opposite sides of the medical display and information board.

14. A medical display and information board comprising
an attachment portion, a first writing space, a first set of pill containers, and a first removable clear cover, where the first set of pill containers comprises a plurality of pill containers, where the first clear cover encloses a pill within one of the plurality of pill containers, where the first clear cover can be removed to insert and/or remove pills from the plurality of pill containers.

15. The medical display and information board of claim 14, wherein the attachment portion comprises a plurality of holes.

16. The medical display and information board of claim 15, further comprising a plurality of binder rings, wherein the plurality of binder rings are secured through the plurality of holes.

17. The medical display and information board of claim 14, further comprising a second set of pill containers and second writing space, where the second set of pill containers comprises a plurality of pill containers.

18. The medical display and information board of claim 17, further comprising a second clear cover, where the second clear cover encloses a pill within one of the plurality of pill containers of the second set of pill containers, where the second clear cover can be removed to insert and/or remove pills from the plurality of pill containers of the second set of pill containers.

19. The medical display and information board of claim 17, where the first set of pill containers and second set of pill containers are accessed on opposite sides of the medical display and information board.

20. The medical display and information board of claim 14, further comprising a second writing space, where the first writing space and second writing space are on opposite sides of the medical display and information board.
